(19) United States
(12) Patent Application Publication
(10) Pub. No.: US 2016/0261354 A1
(43) Pub. Date: Sep. 8, 2016

(54) METHOD FOR TESTING A DEVICE UNDER TEST AND A TEST DEVICE THEREFOR

(71) Applicant: ANRITSU CORPORATION, Kanagawa (JP)

(72) Inventor: Philip Hough, Luton (GB)

(21) Appl. No.: 14/796,685

(22) Filed: Jul. 10, 2015

(30) Foreign Application Priority Data
Mar. 6, 2015 (GB) 1503803.7

(51) Int. Cl. H04B 17/15; H04B 17/29

(52) U.S. Cl. CPC H04B 17/15; H04B 17/29

(57) ABSTRACT

A test device and method for performing a plurality of tests on a DUT, comprising a memory storing configuration data for the plurality of tests, said configuration data defining parameters for at least one list of receive tests; an RF signal generator; an RF signal analyser; and a test sequencer for executing the tests. The test sequencer configures the test device for execution of each list of receive tests, whereby, for each test: the RF signal analyser is arranged to receive a command signal from the DUT, the test sequencer is arranged to retrieve from the memory configuration data for the next test to be executed based on the command signal and to configure the RF signal generator using the configuration data; the RF signal generator is arranged to transmit a test signal to the DUT according to the configuration data.

### FIELD OF THE INVENTION

The present invention relates to a method and test device for testing the RF performance of a device under test.

### BACKGROUND AND PRIOR ART

When devices with RF capabilities are developed, a test device is used to test whether the device under development operates as designed and whether it normally operates according to a communication standard.

In practice, many thousands of tests may be required to confirm correct operation. With the evolution of mobile communication technology, an increasing number of communication standards exist. The staged rollout of new communication technology demands that devices are able to communicate with a wide range of mobile communication technologies, protocols and standards. As such, test devices are designed to simulate a plurality of communication bands, protocols and standards so that a device can be tested against modern standards and also regression tested against older standards. Examples of protocols a mobile communication terminal may be tested against includes Long Term Evolution (LTE), LTE-Advanced (a next-generation standard of LTE), third generation partnership project (3GPP or simply 3G), Edge, and GSM (global system for mobile communications) to name a few. For other wireless communication systems, such as Bluetooth and WiFi, there are similarly a large number of protocol standards to be tested.

WO 2006/047677 A1 to Qualcomm Inc describes a test system having a controller which performs tests on a wireless device to determine antenna performance characteristics. The controller sends a control signal containing a signalling component to a radio signal system which transmits a radio wave signal according to the signalling component to the wireless device. Control signals from the controller are sent for each test sequentially.

The radio frequency (RF) signal of WO 2006/047677 A1 includes data packets, referred to as “over the air” (OTA) data. This OTA data contains synchronisation information and may also contain test configuration data, which are transmitted as subpackets of known communications protocol packets—for example CDMA (code division multiple access) protocol packets.

The wireless device processes the received signal and stores the results along with synchronisation information in a log on the wireless device. The controller 14 also stores information concerning each test in a controller log. At the conclusion of a set of tests, the synchronisation information is used to match information in the controller log and the wireless device log to determine results of the test set.

Typically, it is desired to test the transmit and receive operation of a wireless device. WO 2006/047677 A1 addresses this need by performing transmit and receive tests in sequence. When multiple tests are performed there is an alternating test sequence of transmit, receive, transmit, receive, and so on.

The system of WO 2006/047677 A1 is designed to determine the characteristics of the transmit/receive chain of the wireless device, including the antenna, at various positions. The placement of the wireless device at a range of orientations and positions within an anechoic RF chamber is necessary for this purpose, and the movement of the wireless device to all of the test positions and orientations becomes the factor limiting the time taken to perform a range of tests.

During production testing, however, typically the antennae characteristics are not tested, while the transmit/receive chipset or hardware chain is tested. For such testing, the device does not need to be moved between tests. Testing speed is important in production: the number of tests can increase exponentially given the number of frequency, power setting, packet quantity and waveform type to be tested.

### SUMMARY OF THE INVENTION

Throughout this specification, the term device under test (DUT) shall be used to mean any device having RF capability to be tested. This term includes, for example, a mobile communication device such as a mobile phone or tablet, and devices with RF communication capability based on Bluetooth or IEEE 802.11 (WiFi) such as routers and repeaters.

In accordance with one aspect of the invention, there is provided a method for performing a plurality of tests on a DUT using a test device, both the DUT and the test device having RF transmit/receive capabilities, comprising:
storing configuration data for a plurality of tests on the DUT and the test device, said configuration data defining parameters for at least one list of receive tests;
for each receive test in a list:
   receiving at the test device a command signal from the DUT using the RF transmit/receive capabilities of both devices;
   analysing the command signal using the test device;
   retrieving configuration data for the next test based on the command signal;
   transmitting from the test device to the DUT a test signal, the test signal being generated according to the stored configuration data for that receive test.

Preferably, the stored configuration data defines parameters for at least one list of transmit tests, wherein the method further comprises the steps of:
for each transmit test in a list:
   transmitting from the test device to the DUT a command signal;
   receiving at the test device a test signal from the DUT;
   analysing the test signal using the test device according to the stored configuration data for that transmit test;
   retrieving configuration data for the next test based on the command signal.

Preferably, the configuration data includes frequency, signal power, waveform type and number of packets for a test signal.

Preferably, the command signal is a pulse at a predetermined frequency.

Preferably, the predetermined frequency is the frequency band used in the most recent test.

Preferably, the test device differentiates commands according to command signal pulse length.

Preferably, a plurality of DUTs are to be tested, the method further comprising:
including in the configuration data a port identifier for each test;
using the port identifier as a port address to determine which of a plurality of ports in the test device to use to transmit and receive signals to a DUT.

Preferably, each DUT has a separate port identifier associated therewith.

In accordance with a second aspect of this invention, there is provided a test device for performing a plurality of tests on a DUT, comprising:
a memory storing configuration data for the plurality of tests, said configuration data including at least one list of receive tests;
an RF signal generator;
an RF signal analyser;
a packet analyser;
a test sequencer for executing the tests, the test sequencer arranged to configure the test device into a first mode for execution of each list of receive tests wherein, in the first mode, for each test:
   the RF signal analyser being arranged to receive a command signal from the DUT;
   the packet analyser being arranged to determine characteristics of the received command signal;
   the test sequencer being arranged to determine the next test to be executed based on the characteristics of the received command signal, to retrieve from the memory configuration data for the next test to be executed, and to configure the RF signal generator using the configuration data;
   the RF signal generator being arranged to transmit a test signal to the DUT according to the configuration data.

Preferably, the test sequencer is further arranged to configure the test device into a second mode for execution of each list of transmit tests wherein, in the second mode, for each test:
the test sequencer being arranged to retrieve configuration data for the next test to be executed;
the RF signal generator being arranged to transmit the command signal to the DUT;
the RF signal analyser being arranged to receive a test signal from the DUT;
the packet analyser being arranged to analyse the test signal to determine signal characteristics thereof based on the configuration data;
the test sequencer being arranged to store test signal characteristics determined by the packet analyser in the memory.

Preferably, the configuration data includes frequency, signal power, waveform type and number of packets for a test signal.

Preferably, the command signal is a pulse at a predetermined frequency.

Preferably, the characteristics of the command signal determined by the packet analyser includes pulse length.

Preferably, the predetermined frequency is the configuration data frequency of the most recent test.

Preferably, a plurality of DUTs are to be tested, further comprising: the configuration data including a port identifier for each test, the test sequencer is arranged to use the port identifier as a port address to determine which of a plurality of ports in the test device to use to transmit and receive signals to a DUT.

Preferably, each DUT has a separate port identifier associated therewith.

### BRIEF DESCRIPTION OF THE FIGURES

The invention will now be described with reference to the accompanying drawings, in which:

FIG. 1 is a block diagram of a test device according to an embodiment of the invention;

FIG. 2 is a signal diagram showing signal flow during execution of tests by the test m device of FIG. 1;

FIGS. 3a-3c are flowcharts showing the operation of the test device of FIG. 1;

FIG. 4 is a timing diagram of a command signal used by the test device of FIG. 1; and

FIG. 5 is a block diagram of a test device according to a further embodiment of the invention.

### DESCRIPTION OF PREFERRED EMBODIMENTS

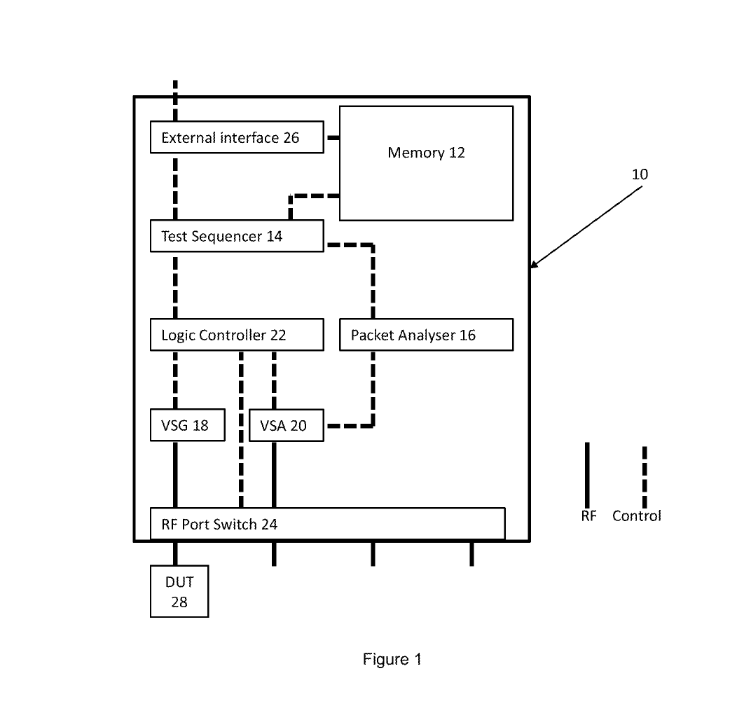

Referring to FIG. 1, there is shown a test device 10 comprising a memory 12, a test sequencer 14, a packet analyser 16, an RF signal generator 18, an RF signal analyser 20, a logic controller 22 and an RF port switch 24.

The memory 12 stores configuration data defining parameters for at least one test as will be described in further detail below. Configuration data may be written to the memory 12 by an external device (not shown), such as a computer, via an external interface 26 of the test device 10.

In the embodiment, the external interface 26 receives data from the external device using the Standard Commands for Programmable Instruments (SCPI) command syntax over an IEEE 488.1 interface (GPIB), however any suitable communication protocol or interface may be used.

One example of configuration data for each test is shown below:
Test n:
   RF Port number (1 to 4)
   Transmission frequency (MHz)
   Transmission power (dBm)
   Waveform (Example: 802.11ac, 80 MHz, MCS8)
   Number of Packets

It is preferred that configuration data is stored as lists, with all tests where the test device 10 transmits a test signal to a DUT using the RF signal generator 18 defined in one list, and all tests where the test device 10 receives a test signal from a DUT using the RF signal analyser 20 defined in another list. It has been discovered that grouping tests in this manner can reduce the time to execute a large number of tests, since most wireless chipsets used in DUTs take longer to switch between transmit and receive modes than they do to reconfigure the current mode. Thus arranging a DUT's tests into one list of all tests where the test device is receiving a test signal from the DUT and another list of all tests where the test device is transmitting a test signal to the DUT improves test execution times due to reduced reconfiguration between tests. Other improvements in test execution times will be described below in relation to the test device of the embodiment.

The external device may also issue instructions to the test device 10, which include instructions to commence executing a list of tests, abort test execution, and report on the status of testing. Instructions from the external device are passed by the external interface 26 to the test sequencer 14 for execution.

The test sequencer 14 passes configuration parameters to logic controller 22 relating to a test to be performed. The logic controller 22 configures the RF signal generator 18, RF signal analyser 20, and RF port switch 24 according to the parameters received from the test sequencer 14.

The RF signal generator 18 and RF signal analyser 20 are each connected to the RF port switch 24, which selectively switches the RF signal generator 18 and RF signal analyser 20 to one of a plurality of RF ports on the test device 10. In the embodiment, the RF signal generator 18 comprises a vector signal generator and the RF signal analyser 20 comprises a vector signal analyser.

The packet analyser 16 receives captured digitised data from the RF signal analyser 20 and analyses this data to determine packet data including the type and quantity of packets received by the RF signal analyser 20. The test sequencer 14 receives packet data from the packet analyser 16 and may either store the packet data in the memory 12 or act on the packet data as will be described in further detail below.

A DUT 28 to be tested is connected to a port of the test device 10. Where testing is focussed on operation of the wireless chipset or receive/transmit chain, the DUT 28 may be connected using a cable attached to the DUT 28's antenna or a test port provided in the DUT 28. The DUT 28 may be placed in an RF-shielded box to reduce interference from RF transmissions from other sources.

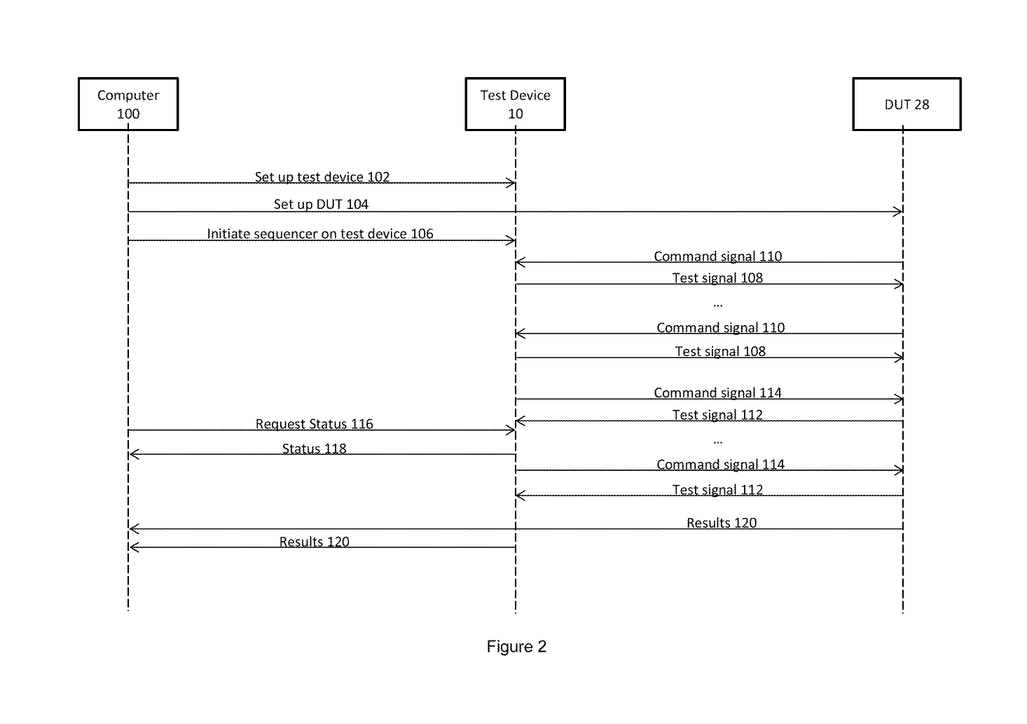

FIG. 2 shows information and signal flow in test setup in which the test device 10 is performing tests on a DUT 28 connected thereto as described above. An external computer 100 is connected to the external interface 26. The computer 100 sends data to the test device 10 at 102.

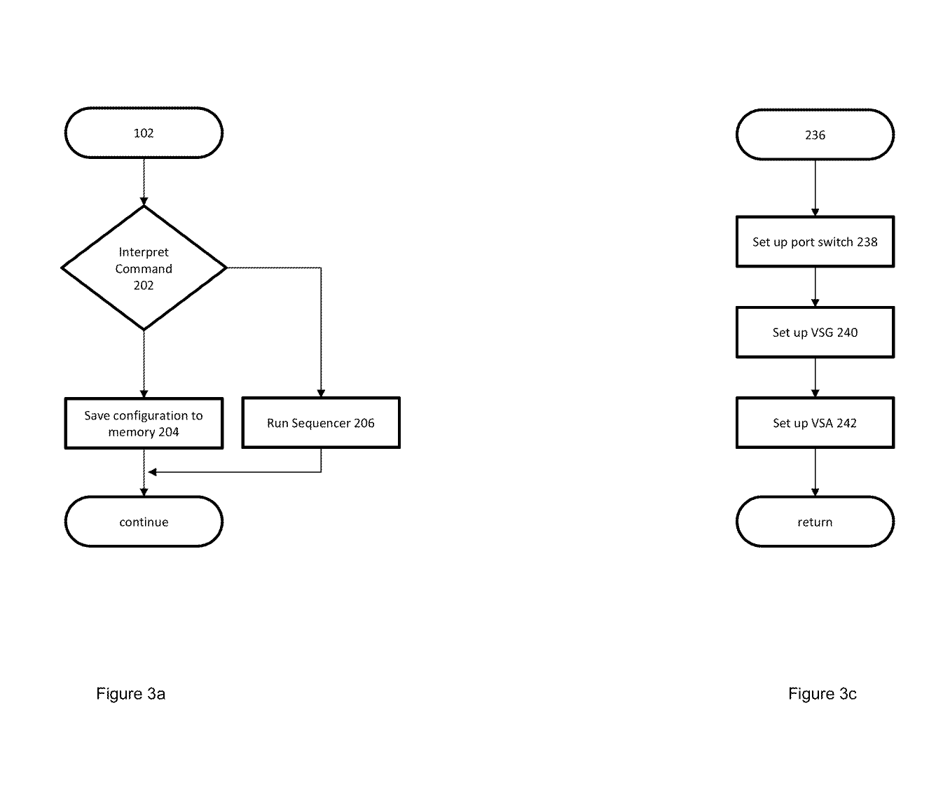

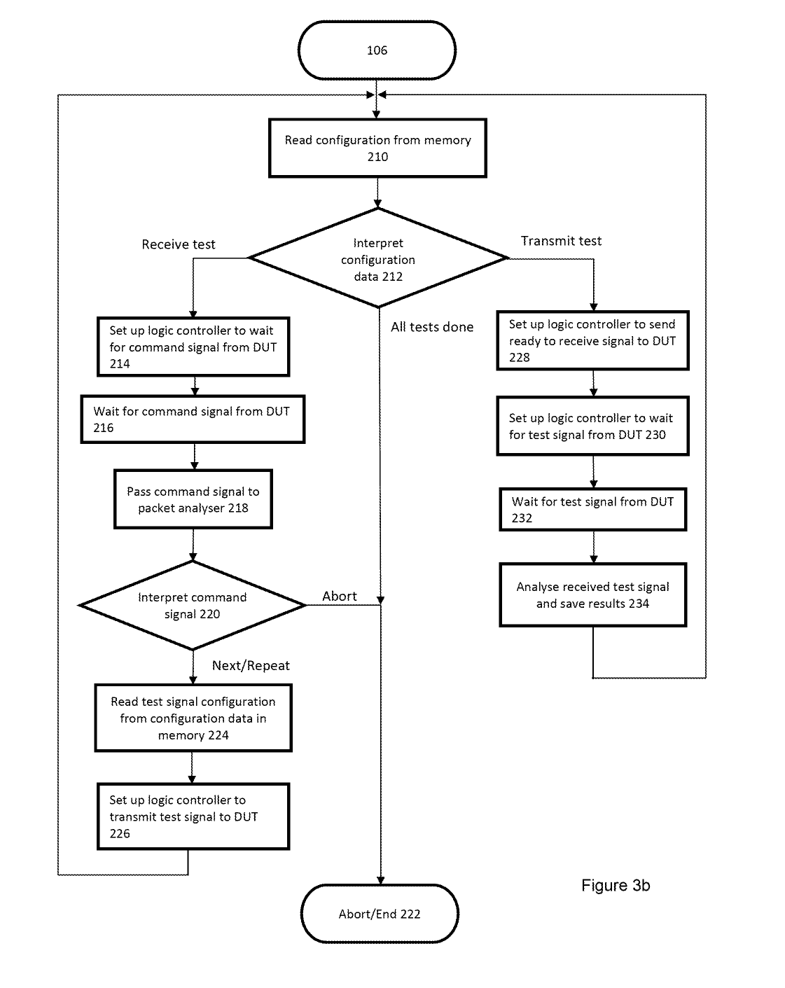

As shown in FIG. 3a, the external interface 26 receives this data from the external computer 100 and interprets the data at 202. If the data is interpreted as test configuration data, the external interface 26 stores the configuration data in the memory 12, shown in FIG. 3a at 204. Data from the external computer may include a list identifier for the list the configuration data is to be added to; alternatively, the configuration data may be appended to the current list in the memory 12. If the data is interpreted as an instruction, the external interface 26 passes the instruction to the test sequencer 14, shown in FIG. 3a at 206.

Returning now to FIG. 2, next the computer 100 sends data to the DUT 28 at 104. This data includes parameters for the tests sufficient to configure the transmit/receive hardware to produce or receive test signals as described below. The DUT 28 includes application software which operates in the same manner as described below with reference to FIGS. 3a-3c for the test device, with the exception that the application software is configuring the DUT 28's transmit/receive hardware rather than the RF signal generator 18 and RF signal analyser 20 of the test device 10. Data sent to the DUT 28 by the computer 100 also includes an instruction to commence the test sequence. In alternative embodiments, the configuration data may be pre-loaded onto the DUT 28 or contained in firmware for production testing.

As would be apparent to the skilled addressee, for any given test, if configuration data sent to the test device 10 indicates transmission of a test signal, corresponding configuration data sent to the DUT indicates receipt of a test signal and vice versa.

Next, the computer 100 sends an instruction to the test device 10 to initiate the test sequencer 14, shown in FIG. 2 at 106. Each test involves the DUT 28 either transmitting or receiving a test signal to/from the test device 10, referred to hereafter as a ‘transmit test’ and ‘receive test’ respectively.

As shown in Figure FIG. 3b, the test sequencer 106 reads configuration data for the next test from the memory 12 at 210. The test sequencer 16 then interprets the configuration data at 212 to determine whether it relates to a receive test, a transmit test, or whether there are no more tests to execute.

If the test is a receive test, the test sequencer 14 configures the test device 10 into a first mode as follows. First, the test sequencer 16 instructs logic controller 22 at 214 to configure the RF signal analyser 20 to commence listening for a command signal from the DUT 28. The test device 10 then waits for a command signal to be received at 216.

When a command signal is received from the DUT 28 (shown in FIG. 2 at 110), the RF signal analyser 20 captures the received command signal and passes the captured signal to the packet analyser 16 at 218. The packet analyser 16 analyses the captured signal to determine command signal characteristics as described below.

The test sequencer 14 receives the command signal characteristics from the packet analyser 16 and determines the corresponding command at 220. If the command signal is ‘abort’, the test sequencer 14 stops executing tests at 222. If the command signal is ‘repeat’ or ‘next item’, the test sequencer 14 reads configuration data for the current or next test in the list in memory 12, respectively, at 224.

Next, the test sequencer 14 instructs the logic controller 22 at 226 to configure the RF signal generator 18 to transmit a test signal to the DUT 28 according to the configuration data. Transmission of a test signal is shown in FIG. 2 at 108. Where needed, the test sequencer 14 may delay instructing the RF signal generator 18 until a predetermined time has elapsed after receipt of a command signal to enable the DUT 28 time to reconfigure. Such predetermined time delay may be preset or may be part of the configuration data.

The test sequencer 14 then resumes operation at step 210 and repeats until either the end of the list is reached or an ‘abort’ command is received at 218.

If the test sequencer 16 interprets the configuration data at 22 as being a transmit test, the test sequencer 14 configures the test device 10 into a second mode as follows. First, the test sequencer 14 instructs logic controller 22 at 228 to configure the RF signal generator 18 to transmit a command signal to the DUT 28 at 216 (as shown in FIG. 2 at 114). In the embodiment the command signal transmitted is ‘next’.

Next, the test sequencer instructs logic controller 22 at 230 to configure the RF signal analyser 20 to listen for a test signal from the DUT 28. The test device 10 then waits for a test signal to be received at 232.

When a test signal is received from the DUT 28 (shown in FIG. 2 at 112), the RF signal analyser 20 captures the received test signal and passes the captured signal to the packet analyser 16. The packet analyser 16 analyses the captured signal to determine test signal characteristics. The test sequencer 14 receives the test signal characteristics from the packet analyser 16 and stores them in the memory 12, shown in FIG. 3b at 234, along with a test identifier, such as test number in a list of tests.

The test sequencer 14 then resumes operation at step 210 and repeats until either the end of the list is reached or an ‘abort’ command is received at 222.

FIG. 3c is a flow chart of the logic controller 22's operation. At 236, the logic controller 22 receives configuration data from the test sequencer 14. At 238, the logic controller 22 sends the RF port number from the configuration data to the RF port switch 24, which connects the RF signal generator 18 and RF signal analyser 20 to the chosen RF port such that a DUT connected to that port is in communication with the RF signal generator 18 and RF signal analyser 20.

At 240, the logic controller 22 sends configuration data relating to an RF signal to the RF signal generator 18, including transmission frequency, transmission power, waveform, and number of packets.

At 242, the logic controller 22 sends configuration data to the RF signal analyser 20 relating to an RF signal to be received, including transmission frequency, transmission power, waveform, and expected number of packets.

In some instances, configuration data received from the test sequencer 14 may include no data for the RF signal generator 18 or alternatively the RF signal analyser 20. In this instance, the logic controller 22 instructs whichever subsystem 18, 20 to enter a standby mode.

Returning again to FIG. 2, the computer 100 can monitor the state of the tests by using typical remote control commands via the external interface 26 to determine when a measurement is complete, shown in FIG. 2 at 116, 118. In this case “measurement complete” means that the end of the list of tests has been reached by the test device 10. Status information—such as the current position in the list of tests—can also be obtained through this mechanism.

When the computer 100 determines that tests are complete, the computer 100 may request results from either or both the test device 10 and DUT 28 for analysis, shown in FIG. 2 at 120. Results of tests where the DUT was transmitting the test signal are stored on the test device 10, while results of tests where the test device 10 was transmitting the test signal are stored on the DUT 28.

As will be appreciated by those skilled in the art, the test sequencing described above allows for faster testing speeds since synchronisation of test execution occurs directly between the test device 10 and the DUT 28, rather than via the external computer 100. The time saved by not transmitting individual test results to the computer 100 via the external interface 26 and waiting for a command signal is not significant for a single test. However when many hundreds or thousands of tests are required the time saved becomes a significant proportion of the overall test time.

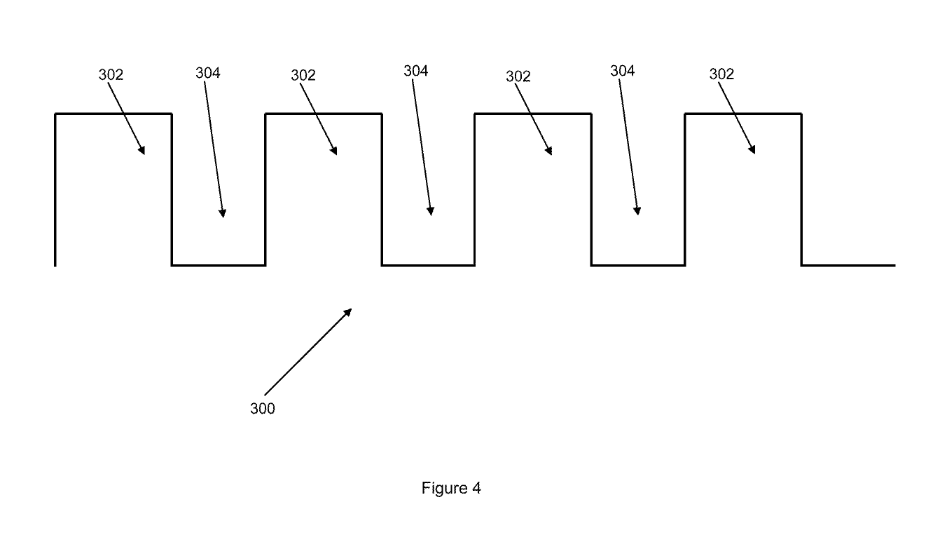

FIG. 4 shows an example of a command signal 300. The command signal 300 comprises a command packet 302 repeated multiple times, with adjacent command packets 302 separated by an interval 304. Sending a command packet 302 multiple times reduces the risk of the command signal being missed by the device receiving the signal, for example if the receiving device had not completed configuring itself for the test. In alternative embodiments, the command signal 300 may consist of a single command packet 302 where the use of multiple packets is not required for reliable communication.

Commands may be encoded in the command packets 302 in any suitable manner, including the packet length or the data contained within the packet.

In a preferred embodiment, however, each command is encoded by the length of each packet 302. For example, “Next Item” corresponds to a command packet length of 20 μs, “Abort” 70 μs, and “Repeat” 120 μs. The interval 304 may be set to any suitable value, for example 50 μs. The use of pulse-length encoding of the command signal as described here is simple for both the DUT and test device to encode/decode. In addition, it is independent of the transmission frequency or waveform standard being tested. It is preferred that the command signal is transmitted at the same frequency as the preceding test signal, to minimise any reconfiguration of DUT and test device needed.

Command signals are transmitted between the test device 10 and DUT 28 using each device's RF transmit/receive capabilities. This is commonly referred to as ‘over the air’ (OTA) signalling. OTA signalling is preferred for this embodiment because it avoids the use of a second connection between the DUT and test device which may use a second, slower interface, would require additional setup time, and may add to the cost, complexity and power consumption of the DUT if the second interface was solely used for testing.

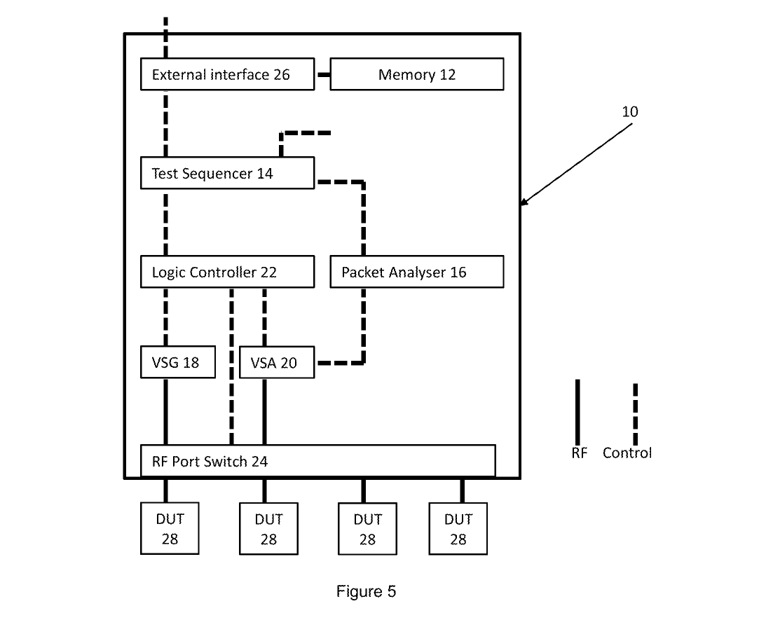

FIG. 5 shows a further embodiment where multiple DUTs are connected to the test device 10, with like reference numerals denoting like parts. Operation of the test device 10 is the same as described in relation to FIG. 1, while the RF port number in the configuration data is used to determine which of the DUTs each test is performed on.

Testing multiple DUTs 28 has additional benefits for production testing, since one DUT can be connected to the test device 10 whilst another is being tested.

Alternative embodiments, lists of tests may be stored in memory on test device 10, whereby the computer 10 may requests initiation of the test sequencer 14 for a pre-m stored list.

Modifications and variations such as would be apparent to a person skilled in the art are within the scope of the invention.

1. A method for performing a plurality of tests on a DUT using a test device, both the DUT and the test device having RF transmit/receive capabilities, comprising:
storing configuration data for a plurality of tests on the DUT and the test device, said configuration data defining parameters for at least one list of receive tests;
for each receive test in a list:
receiving at the test device a command signal from the DUT using the RF transmit/receive capabilities of both devices;
analysing the command signal using the test device;
retrieving configuration data for the next test based on the command signal;
transmitting from the test device to the DUT a test signal, the test signal being generated according to the stored configuration data for that receive test.

2. The method of claim 1, wherein the stored configuration data defines parameters for at least one list of transmit tests, further comprising the steps of:
for each transmit test in a list:
transmitting from the test device to the DUT a command signal;
receiving at the test device a test signal from the DUT;
analysing the test signal using the test device according to the stored configuration data for that transmit test;
retrieving configuration data for the next test based on the command signal.

3. The method of claim 2, wherein the configuration data includes frequency, signal power, waveform type and number of packets for a test signal.

4. The method of claim 3, wherein the command signal is a pulse at a predetermined frequency.

5. The method of claim 4, wherein the predetermined frequency is the frequency band used in the most recent test.

6. The method of claim 5, wherein the test device differentiates commands according to command signal pulse length.

7. The method of claim 1, wherein a plurality of DUTs are to be tested, the method further comprising:
including in the configuration data a port identifier for each test;
using the port identifier as a port address to determine which of a plurality of ports in the test device to use to transmit and receive signals to a DUT.

8. The method of claim 7, wherein each DUT has a separate port identifier associated therewith.

9. A test device for performing a plurality of tests on a DUT, both the DUT and the test device having RF transmit/receive capabilities, comprising:
a memory storing configuration data for the plurality of tests, said configuration data including at least one list of receive tests;
an RF signal generator;
an RF signal analyser;
a packet analyser;
a test sequencer for executing the tests, the test sequencer arranged to configure the test device into a first mode for execution of each list of receive tests wherein, in the first mode, for each test:
the RF signal analyser being arranged to receive a command signal from the DUT;
the packet analyser being arranged to determine characteristics of the received command signal;
the test sequencer being arranged to determine the next test to be executed based on the characteristics of the received command signal, to retrieve from the memory configuration data for the next test to be executed, and to configure the RF signal generator using the configuration data;
the RF signal generator being arranged to transmit a test signal to the DUT according to the configuration data.

10. The test device of claim 9, wherein test sequencer is further arranged to configure the test device into a second mode for execution of each list of transmit tests wherein, in the second mode, for each test:
the test sequencer being arranged to retrieve configuration data for the next test to be executed;
the RF signal generator being arranged to transmit the command signal to the DUT;
the RF signal analyser being arranged to receive a test signal from the DUT;
the packet analyser being arranged to analyse the test signal to determine signal characteristics thereof based on the configuration data;
the test sequencer being arranged to store test signal characteristics determined by the packet analyser in the memory.

11. The test device of claim 10, wherein the configuration data includes frequency, signal power, waveform type and number of packets for a test signal.

12. The test device of claim 11, wherein the command signal is a pulse at a predetermined frequency.

13. The test device of claim 12, wherein the characteristics of the command signal determined by the packet analyser includes pulse length.

14. The test device of claim 12, wherein the predetermined frequency is the configuration data frequency of the most recent test.

15. The test device of claim 9, wherein a plurality of DUTs are to be tested, further comprising: the configuration data including a port identifier for each test, the test sequencer is arranged to use the port identifier as a port address to determine which of a plurality of ports in the test device to use to transmit and receive signals to a DUT.

16. The test device of claim 15, wherein each DUT has a separate port identifier associated therewith.
